(19) United States
(12) Patent Application Publication
(10) Pub. No.: US 2019/0354306 A1
(43) Pub. Date: Nov. 21, 2019

(54) AVAILABLE-SPACE MANAGEMENT METHOD FOR NONVOLATILE MEMORY, ACCESS DEVICE WHICH STORES DATA TO INFORMATION STORAGE DEVICE WITH NONVOLATILE MEMORY, INFORMATION STORAGE DEVICE, AND INFORMATION STORAGE SYSTEM

(71) Applicant: PANASONIC INTELLECTUAL PROPERTY MANAGEMENT CO., LTD., Osaka (JP)

(72) Inventor: Takuji MAEDA, Osaka (JP)

(21) Appl. No.: 16/530,658

(22) Filed: Aug. 2, 2019

Related U.S. Application Data
(63) Continuation of application No. PCT/JP2018/014481, filed on Apr. 4, 2018.

(30) Foreign Application Priority Data
Apr. 7, 2017 (JP) 2017-076553

(51) Int. Cl. G06F 3/06; G06F 16/11

(52) U.S. Cl. CPC G06F 3/0644; G06F 3/064; G06F 16/122; G06F 3/0607; G06F 3/0679

(57) ABSTRACT

An available-capacity management method is a method for managing an available capacity of an information recording device including a nonvolatile memory configured to store file data, the method being performed by an access device configured to access the information recording device. This method includes: at time of mounting of the information recording device on the access device, retrieving, from the information recording device, available-capacity management information according to which available capacities of recording areas are managed; reconstructing the available-capacity management information based on a state of recording of data on the nonvolatile memory; updating the available-capacity management information in response to writing of data into the nonvolatile memory; and, at time of unmounting of the information recording device, recording the available-capacity management information on the information recording device.

### TECHNICAL FIELD

The present disclosure relates to an access device for writing data into an information storage device (information recording device) that stores data in a nonvolatile memory and manages the data as a file, and to an information storage system (information recording system) including the access device. The present disclosure also relates to a method of managing an available space (available capacity) of a nonvolatile memory.

### BACKGROUND ART

A variety of media are used to record digital data such as music content and image data. Examples of such media include magnetic disks, optical discs, and magneto-optical disks. Among such recording media, memory cards that use semiconductor memories including flash read only memories (ROMs) as recording elements are compact, and thus have become rapidly widespread mainly in compact portable devices, such as movie cameras, digital still cameras, and mobile telephone terminals. In particular, semiconductor memories, which have conventionally been used as detachable, removable media like memory cards, have recently found application as built-in memories. For example, semiconductor memories, such as flash ROMs, are built in devices and used in place of hard disks.

A memory card and a built-in memory mainly use a semiconductor device called a NAND flash memory. The NAND flash memory is a recording element on which recorded data can be erased and new data can be recorded. Like a conventional hard disk, the NAND flash memory can be used to form an information recording device that is rewritable a plurality of number of times.

A conventional way to manage data stored in a memory card or a built-in memory uses a file system. Data managed with a file system can be shared as files between a plurality of devices that can interpret the same file system. Such file system management enables a user to easily refer to or copy his/her stored data on the plurality of devices.

A file system that has conventionally achieved most widespread use is a file allocation table (FAT) file system. The FAT file system centrally manages areas with a file allocation table (FAT). Since the FAT file system has a relatively simple structure and is easily implemented, the FAT file system is widely used as the file system in, for example, flexible disks, hard disks of personal computers, and memory cards. Recently, extended FAT (exFAT) file system, which is an extended version of the FAT file system, is also in wide use. The exFAT file system uses a file allocation table and an allocation bitmap. According to the allocation bitmap, an availability state is managed based on clusters.

Recent semiconductor memory cards such as a secure digital (SD) card have a significantly increased capacity as a result of microfabrication and lamination of flash memories. Due to the increase in capacity, a size of area management information such as FAT and the allocation bitmap is also increased. Consequently, it takes time to calculate an entire available capacity and to search for an available cluster for recording a file. Thus, for example, in a case where a user wishes to capture an image with a digital still camera or the like immediately after turning on the digital still camera or the like, it may take time to search for an available cluster and thus immediate image capturing cannot be performed, disadvantageously. In addition, in a case where available clusters are scattered, it may take time to search for an available cluster during moving image capturing, which may potentially interrupt the moving image capturing.

PTL 1 discloses an access device and a method each of which enables quick calculation of an available capacity with a file system, thereby making it possible to reduce time taken from initialization of the file system to start of recording.

### CITATION LIST

### Patent Literature

PTL 1: International Publication No. WO2009/150810

### SUMMARY

The present disclosure provides an available-capacity management method and an access device each of which enables quick searching for an available capacity in an information recording device.

A first aspect of the present disclosure provides a method for managing an available capacity of an information recording device including a nonvolatile memory configured to store file data, the method being performed by an access device configured to access the information recording device. This method includes: at time of mounting of the information recording device on the access device, retrieving, from the information recording device, available-capacity management information according to which available capacities of recording areas are managed, each of the recording areas having a predetermined length; reconstructing the available-capacity management information based on a state of recording of data on the nonvolatile memory; updating the available-capacity management information in response to writing of data into the nonvolatile memory; and, at time of unmounting of the information recording device, recording the available-capacity management information on the information recording device.

A second aspect of the present disclosure provides an access device configured to access an information recording device including a nonvolatile memory configured to store file data. The access device includes an interface via which the access device transmits the file data to the information recording device and the access device receives the file data from the information recording device and a control unit configured to control recording of the file data on the information recording device with use of a file system. At time of mounting of the information recording device on the access device, the control unit retrieves, from the information recording device, available-capacity management information according to which available capacities of recording areas are managed, each of the recording areas having a predetermined length. The control unit reconstructs the available-capacity management information based on a state of recording of data on the nonvolatile memory. The control unit updates the available-capacity management information in response to writing of data into the nonvolatile memory. At time of unmounting of the information recording device, the control unit records the available-capacity management information on the information recording device.

A third aspect of the present disclosure provides an information recording device including a nonvolatile memory configured to store file data. In the information recording device, the file data is managed based on predetermined data units (clusters) according to a file system. The nonvolatile memory includes: area management information according to which pieces of information about the respective data units are managed; an entry group incorporating at least one fixed-length entry being generated for every file data and storing management information including information indicating a name and a size of a file; and available-capacity management information according to which available capacities of recording areas corresponding to block areas being defined by the area management information and each including a predetermined number of the data units are managed. The entry group includes an area identification entry identifying an area storing the available-capacity management information.

A fourth aspect of the present disclosure provides an information recording system including an information recording device including a nonvolatile memory configured to store file data and an access device configured to access the information recording device. The information recording device stores available-capacity management information according to which available capacities of recording areas are managed, each of the recording areas having a predetermined length. The access device includes an interface via which the access device transmits the file data to the information recording device and the access device receives the file data from the information recording device and a control unit configured to control recording of the file data on the information recording device with use of a file system. The control unit retrieves the available-capacity management information from the information recording device, at time of mounting of the information recording device on the access device. The control unit reconstructs the available-capacity management information based on a state of recording of data on the nonvolatile memory. The control unit updates the available-capacity management information in response to writing of data into the nonvolatile memory. The control unit records the available-capacity management information on the information recording device at time of unmounting of the information recording device.

The method for managing an available capacity and the access device according to the present disclosure enable quick searching for an available capacity in an information recording device. Consequently, it is possible to reduce time taken to write data into the information recording device.

### BRIEF DESCRIPTION OF DRAWINGS

FIG. 1 is a view illustrating a configuration of an information recording system according to a first exemplary embodiment of the present disclosure.

FIG. 2 is a view for explaining an area within a logical address space of a nonvolatile memory.

FIG. 3 is a view for explaining block areas (AB block_1 to AB block_6) set in an allocation bitmap.

FIG. 4 is a view illustrating a structure of a block available capacity table.

FIG. 5 is a view for explaining how a new block available capacity table is constructed.

FIG. 6 is a view illustrating a control sequence between an application control unit and a file system control unit.

FIG. 7 is a view for explaining how the block available capacity table is reconstructed.

FIG. 8 is a view illustrating a structure of a basic entry.

FIG. 9 is a view illustrating a structure of a name entry.

FIG. 10 is a view illustrating a structure of a table-storage-area identification entry.

FIG. 11 is a view illustrating another method for managing the block available capacity table.

FIG. 12 is a view illustrating a structure of a block-available-capacity-table entry.

FIG. 13 is a view for explaining block areas (FAT block_1 to FAT block_8) set in a file allocation table (FAT).

### DESCRIPTION OF EMBODIMENTS

Exemplary embodiments will be described in detail below with reference to the drawings as appropriate. However, detailed description more than necessary may be omitted. For example, detailed description of well-known matters and redundant description of structures that are substantially the same may be omitted. This is to avoid unnecessary redundancy in the following description and to facilitate understanding by those skilled in the art.

Note that the inventor(s) of the present disclosure provide the accompanying drawings and the following description in order to allow those skilled in the art to fully understand the present disclosure, and do not intend to limit the subject matter as described in the appended claims.

Hereinafter, the exemplary embodiments of the present disclosure will be described with reference to the accompanying drawings.

### First Exemplary Embodiment

### [1-1. Configuration]

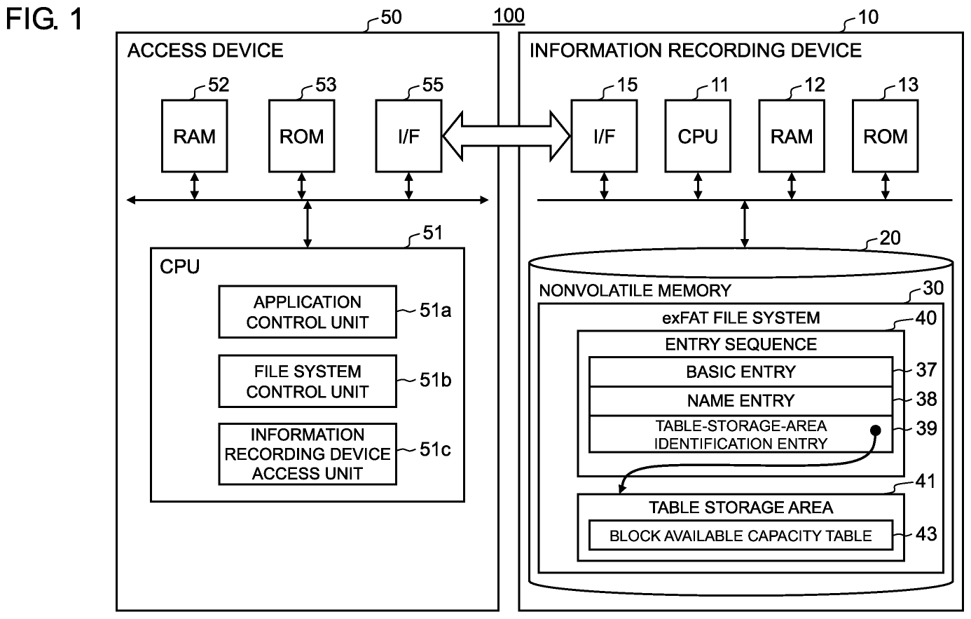

FIG. 1 is a view illustrating a configuration of an information recording system according to a first exemplary embodiment of the present disclosure. As illustrated in FIG. 1, information recording system 100 includes information recording device 10 configured to store file data and access device 50 configured to write and read data into and from information recording device 10. Examples of information recording device 10 encompass a memory card and a solid state drive (SSD). Examples of access device 50 encompass a personal computer, a tablet computer, a television, a hard disk drive (HDD) recorder, a digital still camera, a video camera, and a smartphone.

### [1-1-1. Access Device]

As illustrated in FIG. 1, access device 50 includes central processing unit (CPU) 51, random access memory (RAM) 52, read only memory (ROM) 53, and interface (I/F) 55.

CPU 51 uses RAM 52 as a temporary storage area, and executes a program retrieved from ROM 53 to implement the features described below.

Interface 55 is an interface circuit via which information recording device 10 is connected to access device 50. Interface 55 is used to transmit and receive a control signal and data to and from information recording device 10. Namely, via interface 55, file data is written into information recording device 10 and file data is retrieved from information recording device 10.

ROM 53 stores programs for causing CPU 51 to operate as application control unit 51a, file system control unit 51b, and information recording device access unit 51c. In the present exemplary embodiment, each of application control unit 51a, file system control unit 51b, and information recording device access unit 51c is achieved by cooperation between CPU 51 and a corresponding one(s) of the programs (software). Alternatively, all of or some of application control unit 51a, file system control unit 51b, and information recording device access unit 51c may be achieved by hardware.

Application control unit 51a controls entire operation of access device 50, such as data generation and power source control.

File system control unit 51b performs control for managing data as a file with use of a file system. In the present exemplary embodiment, exFAT file system 30 will be described as one example of the file system of the information recording system.

File system control unit 51b performs a process of calculating an available capacity of information recording device 10. Information used by file system control unit 51b to perform the available capacity calculating process is stored in RAM 52.

In order to determine an available capacity of a storage area, file system control unit 51b refers to block available capacity table 43 (described in detail later) retrieved from information recording device 10. Specifically, file system control unit 51b performs the determination on the available capacity based on areas each having a predetermined size. Then, upon obtaining an available capacity minimum necessary to record data, file system control unit 51b starts recording the data. Consequently, for information recording system 100, it is possible to reduce process time taken from initialization of the file system to start of recording.

Information recording device access unit 51c controls transmission and reception of a command and data with respect to information recording device 10. Specifically, for example, information recording device access unit 51c receives, from file system control unit 51b, data as well as information indicating a size and an address of data. Then, information recording device access unit 51c records the data of the designated size on a designated location in a recording area of information recording device 10.

### [1-1-2. Information Recording Device]

Information recording device 10 includes CPU 11, RAM 12, ROM 13, interface 15, and nonvolatile memory 20. Interface 15 is a circuit for connection with access device 50. Similarly to interface 55 of access device 50, interface 15 is a circuit via which information recording device 10 transmits and receives a control signal and data.

ROM 13 stores a program for controlling information recording device 10. CPU 11 uses RAM 12 as a temporary storage area, and executes a program retrieved from ROM 13 in order to implement the features described below.

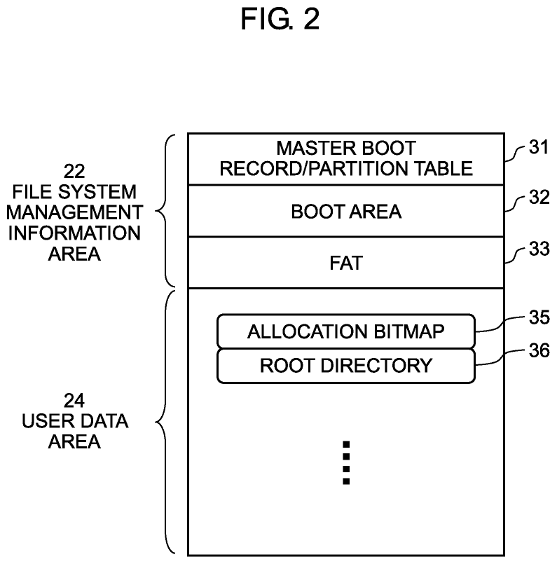

Nonvolatile memory 20 is a storage element on which data supplied from access device 50 is recorded. For example, nonvolatile memory 20 may be a NAND flash memory. The recorded data is managed according to the file system. Specifically, a logical address space of nonvolatile memory 20 stores a structure of various data used by the FAT file system as those illustrated in FIG. 2.

With reference to FIG. 2, at the beginning of the logical address space of nonvolatile memory 20, file system management information area 22 is defined. File system management information area 22 is a region for storing management information about the file system, such as information indicating an area allocation unit and a size of an area managed by the file system. User data area 24 for storing user data is defined to follow file system management information area 22.

File system management information area 22 stores the management information about the file system. The management information includes master boot record/partition table 31, boot area 32, and file allocation table (FAT) 33. These pieces of information stored in file system management information area 22 include information required to manage user data area 24.

Master boot record/partition table 31 is a region for storing information used to manage a plurality of areas called partitions, which are obtained by dividing an area of the logical address space managed by the file system.

Boot area 32 is a region for storing information about management within a single partition. The management information may be, for example, information about an area management unit within the single partition. FAT (33) is a region for storing information about a storage position of data constituting the file.

User data area 24 is managed in a state where user data area 24 is divided into management units called clusters, each of which has a size of 512 bytes to several hundreds of kilobytes. Each of the clusters stores data constituting the file. A file constituted by large size data is stored with use of a plurality of clusters. Links between the clusters are managed by link information stored in FAT (33). A single entry (e.g., 32 bits) in FAT (33) corresponds to a single cluster. A part of user data area 24 is used to store information about a file and a sub-directory (directory entry) immediately below a root directory.

User data area 24 stores allocation bitmap 35. Allocation bitmap 35 is information according to which the states of the clusters (as to whether or not the clusters are available) are managed. A single bit in allocation bitmap 35 corresponds to a single cluster. The value of each bit indicates whether or not a cluster corresponding to the bit is available.

User data area 24 also includes root directory 36. Information indicative of a first cluster number of root directory 36 is placed in boot area 32. Root directory 36 stores an allocation bitmap entry (not illustrated) that is information indicating a first cluster number of allocation bitmap 35.

### [1-1-3. Block Available Capacity Table]

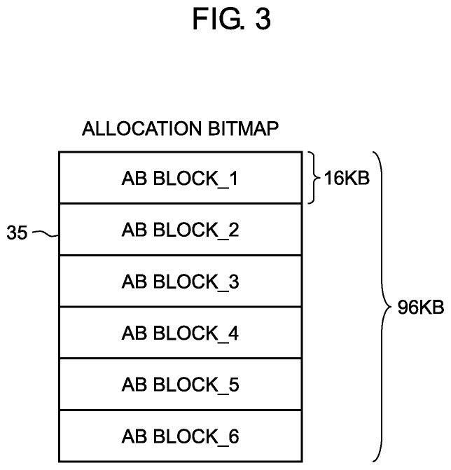

According to the present exemplary embodiment, the entire area of allocation bitmap 35 is divided into blocks (areas) of a fixed length, and available capacities are managed based on the blocks. FIG. 3 is a view for explaining block areas (AB block_ 1 to AB block_6) set in the allocation bitmap. As illustrated in FIG. 3, allocation bitmap 35 of 96 KB is divided into block areas (hereinafter, referred to as “AB blocks”) of a fixed length. Here, each AB block has a size of 16 KB. Dividing allocation bitmap 35 of 96 KB at every 16 KB for management yields a total of six blocks of AB block_1 to AB block_6.

In a range of the clusters allocated to each of the AB blocks, a number of available clusters is counted. In allocation bitmap 35, a single bit corresponds to a single cluster. Thus, in the example shown in FIG. 3, a single AB block includes 16 K×eight clusters. Thus, in a range of 16 K×eight clusters, a number of available clusters is counted. The number of available clusters counted for each of the AB blocks is managed by block available capacity table 43.

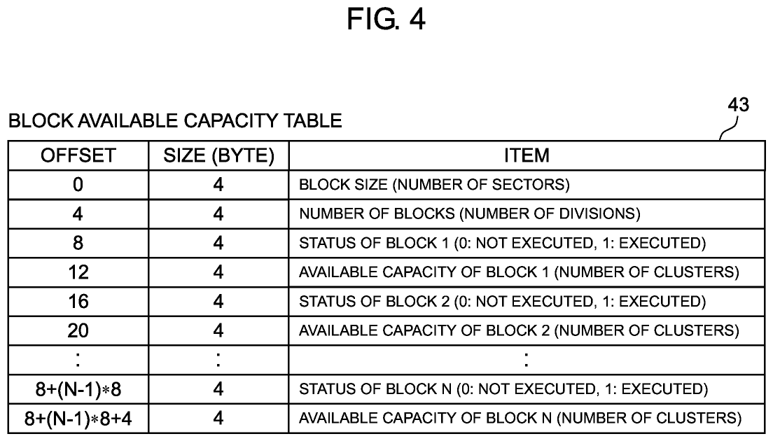

FIG. 4 is a view illustrating a structure of block available capacity table 43. Block available capacity table 43 includes fields of “block size”, “number of blocks”, “status of block m”, and “available capacity of block m” (m=1, 2, . . . N).

The “block size” indicates a size of a single AB block, and is represented by a number of sectors. The “number of blocks” indicates a number of AB blocks (a number of divisions) obtained by dividing allocation bitmap 35 by a fixed length. The “status of block m” is information indicating whether or not an m-th AB block has been subjected to the available capacity calculating process. If block m has been subjected to the available capacity calculating process, i.e., if an available capacity of block m has been calculated, the status of block m is set at “1”. Meanwhile, if block m has not been subjected to the available capacity calculating process, i.e., if the available capacity of block m has not been calculated, the status of block m is set at “0”. The “available capacity of block m” is information indicating available capacities of clusters allocated to the m-th AB block, and is represented by a number of clusters. A sum total of available capacities of all the AB blocks means an available capacity of entire user data area 24.

According to the present exemplary embodiment, file system control unit 51b calculates available capacities of recording areas corresponding to the respective AB blocks (in the example shown in FIG. 3, in a range of 16 K×eight clusters), and manages the calculated available capacities with use of block available capacity table 43.

### [1-2. Operation]

The following will describe how information recording system 100 configured as described above operates.

### [1-2-1. Construction of Block Available Capacity Table]

Access device 50 analyzes a data written state of nonvolatile memory 20 of information recording device 10 to construct block available capacity table 43. The following will describe how block available capacity table 43 is constructed.

File system control unit 51b of access device 50 retrieves allocation bitmap 35 from information recording device 10, and causes allocation bitmap 35 to be stored in RAM 52.

File system control unit 51b sequentially checks bits in each of the AB blocks in allocation bitmap 35 to determine whether or not a cluster corresponding to each of the bits is available. Namely, file system control unit 51b calculates a total number of available clusters in a cluster group allocated to each of the AB blocks. The total number of available clusters in each of the AB blocks thus obtained is stored in the “available capacity of block m” (hereinafter, referred to as an “available capacity”) in block available capacity table 43. Concurrently, the “status of block m” (hereinafter, referred to as a “status”) is set at “1” (executed) for the block having been subjected to calculation of available clusters.

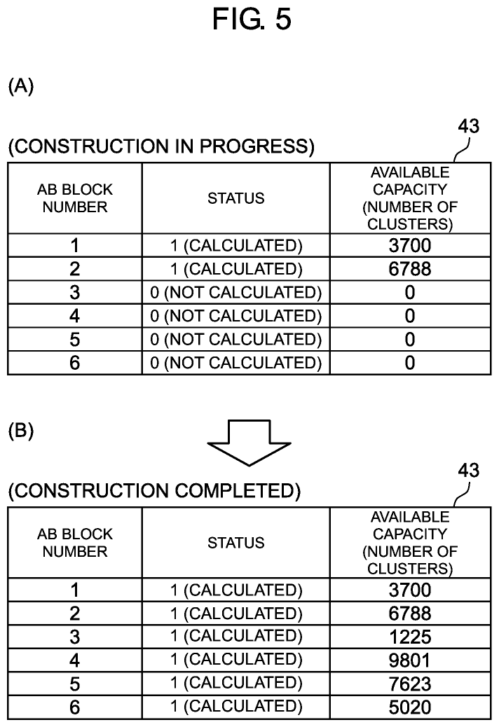

FIG. 5 is a view illustrating how new block available capacity table 43 is constructed. FIG. 5(A) shows a state where construction of block available capacity table 43 is in progress, whereas FIG. 5(B) shows a state where the construction of block available capacity table 43 is completed. In FIG. 5(A), available capacities of first and second AB blocks have been calculated. Consequently, statuses of the first and second AB blocks are set at “1”, which indicates a state where the calculation has been done (executed). In addition, numbers of available clusters having been counted for the first and second AB blocks are respectively set as the available capacities of the first and second AB blocks. On the other hand, available capacities of third to sixth AB blocks have not been calculated. Thus, the statuses of these AB blocks are set at “0”, which indicates a state where the calculation has not been done (not executed). In addition, “0” is set as the available capacity of each of these AB blocks.

Thereafter, when the construction of block available capacity table 43 is completed, all of the AB blocks are set at “1”, which indicates a state where the calculation has been done (executed). In addition, numbers of available clusters having been counted for all of the AB blocks are respectively set as the available capacities of all of the AB blocks, as illustrated in FIG. 5(B).

[1-2-2. Control Sequence between Application Control Unit and File System Control Unit]

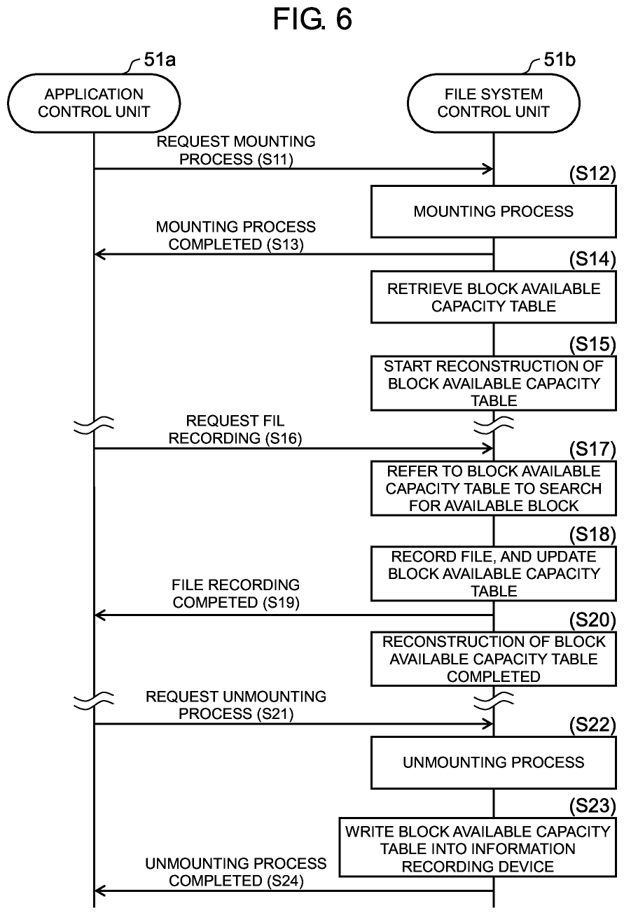

With reference to FIG. 6, the following will describe a control sequence between application control unit 51a and file system control unit 51b. Assume that, in the following process, block available capacity table 43 has been already constructed.

First, application control unit 51a gives file system control unit 51b a request to execute a mounting process (S11).

In response to the request, file system control unit 51b executes the mounting process (S12). The mounting process refers to a process for initializing the file system, which is performed firstly in order to use the file system. Specifically, management information about the file system is retrieved from nonvolatile memory 20 of information recording device 10. Then, information (e.g., FAT (33)) required to control the file system in the information thus retrieved is stored in RAM 52. When the mounting process is completed, file system control unit 51b notifies application control unit 51a of completion of the mounting process (S13).

File system control unit 51b retrieves block available capacity table 43 from information recording device 10 (S14). Block available capacity table 43 thus retrieved is stored in RAM 52.

Here, in a case where information recording device 10 of the present exemplary embodiment is mounted on and used in an access device that cannot interpret block available capacity table 43, updating of block available capacity table 43 would not take place in response to recording of data. In such a case, a mismatch may potentially occur between an actual state of information recording device 10 and a state indicated by block available capacity table 43. In order to address this, block available capacity table 43 is reconstructed so that block available capacity table 43 is up to date. Specifically, file system control unit 51b starts reconstruction of block available capacity table 43 having been retrieved (S15). The reconstruction process of block available capacity table 43 is executed on a background.

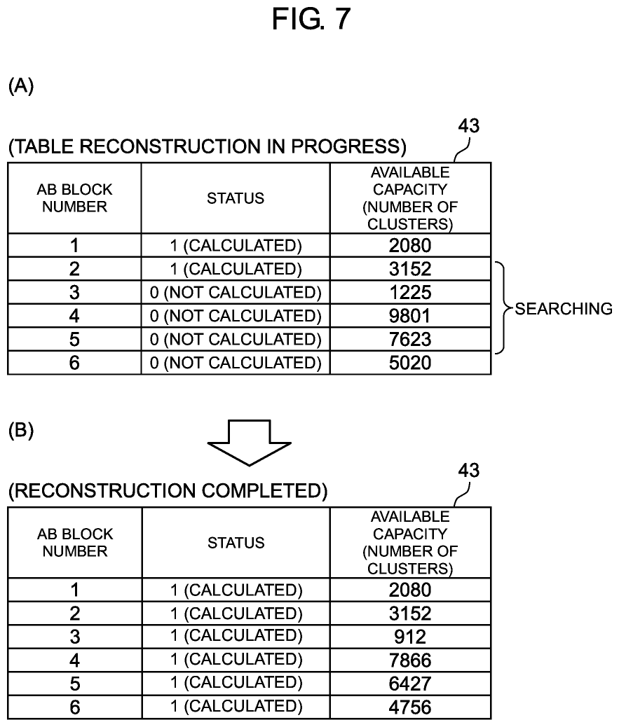

FIG. 7 is a view illustrating how block available capacity table 43 is reconstructed. FIG. 7(A) shows a state where reconstruction of block available capacity table 43 is in progress, whereas FIG. 7(B) shows a state where the reconstruction of block available capacity table 43 is completed. Pieces of information about the blocks in block available capacity table 43 are updated according to progress of the reconstruction. For example, in FIG. 7(A), available capacities of first and second AB blocks have been calculated. Consequently, statuses of the first and second AB blocks are set at “1”, which indicates a state where recalculation has been done. In addition, numbers of available clusters having been counted for the first and second AB blocks this time are respectively set as the available capacities of the first and second AB blocks. On the other hand, available clusters of third to sixth AB blocks have not been calculated. Thus, statuses of the third to sixth AB blocks are set at “0”, which indicates a state where recalculation has not been done. As the available capacities of the third to sixth AB blocks, numbers of clusters in the previous states (the states prior to the reconstruction) are set.

When application control unit 51a gives a request to record a file (S16), file system control unit 51b refers to block available capacity table 43 to search for an available block (S17). At this time, if the reconstruction of block available capacity table 43 is in progress, file system control unit 51b refers to block available capacity table 43 (e.g., a table in the state shown in FIG. 7(A)) under reconstruction. Although an available capacity of an AB block whose status is “0” does not have an accurate value, file system control unit 51b refers to the available capacity of such an AB block just as a guide. Meanwhile, if the reconstruction of block available capacity table 43 is completed, file system control unit 51b refers to block available capacity table 43 having been reconstructed (e.g., a table in the state shown in FIG. 7(B)).

Specifically, file system control unit 51b refers to block available capacity table 43. Then, file system control unit 51b first searches for an AB block whose status is “1” (calculated) and whose available capacity (a number of available clusters) is equal to or greater than a predetermined value, and determines such an AB block as an “available block”. If two or more such AB blocks are found, file system control unit 51b selects, as the “available block”, a block having the largest available capacity among these AB blocks. Meanwhile, if such an AB block is not found, file system control unit 51b searches for an AB block having the largest available capacity in the AB blocks whose statuses are “0” (not calculated), and determines such an AB block as the “available block”.

If the “available block” is found as a result of the searching for the available block, file system control unit 51b records the file data on available clusters among clusters allocated to the available block thus found (S18). In response to recording of the file, file system control unit 51b updates block available capacity table 43 (S18). If no “available block” is found, file system control unit 51b notifies application control unit 51a that an error has occurred, and does not record the file.

When the recording of the file is completed, file system control unit 51b notifies application control unit 51a that recording of the file has been completed (S19).

In the course of time, the reconstruction of block available capacity table 43 executed in the background is completed (S20).

Thereafter, when application control unit 51a gives file system control unit 51b a request to execute an unmounting process (S21), file system control unit 51b executes the unmounting process (S22). Then, file system control unit 51b writes, on a predetermined area of nonvolatile memory 20 of information recording device 10, block available capacity table 43 stored in RAM 52 (S23).

In the end, file system control unit 51b notifies application control unit 51a of completion of the unmounting process (S24).

As described above, at time of unmounting of information recording device 10, block available capacity table 43 is written into information recording device 10. Consequently, when access device 50 is mounted on information recording device 10 again for recording data on information recording device 10, it is possible to obtain the latest availability state by referring to block available capacity table 43. Note that, in a case where the access device that was used with information recording device 10 the last time is the one that cannot interpret block available capacity table 43, block available capacity table 43 may not indicate an accurate state in some cases. However, even in such a case, it is possible to refer to the state indicated by block available capacity table 43 just as a guide for an availability state of each block.

### [1-2-3. Management of Block Available Capacity Table]

The following will describe a method of managing block available capacity table 43. There has been known a method of managing various kinds of files and other information with use of multiple types of entry information having a size of 32 bytes. For example, International Publication No. WO2009/122743 discloses a method of managing file data with use of an entry sequence, which is an entry group incorporating entries each of which is generated for every file data, has a fixed length, and stores management information such as a name and a size of the file. This method performs file management with use of the entry sequence including entries (a basic entry, a name entry) storing management information such as the name and size of the file, which is followed by a special entry (extent information entry) storing extended information. In this manner, this method manages the extended information. The special entry identifies a cluster to store the extended information. A checksum of the series of entries in the entry sequence is calculated, and the checksum thus calculated is stored in a certain entry.

The present exemplary embodiment applies the management technique to manage block available capacity table 43. Specifically, as illustrated in FIG. 1, nonvolatile memory 20 of information recording device 10 has entry sequence 40 including basic entry 37, name entry 38, table-storage-area identification entry 39.

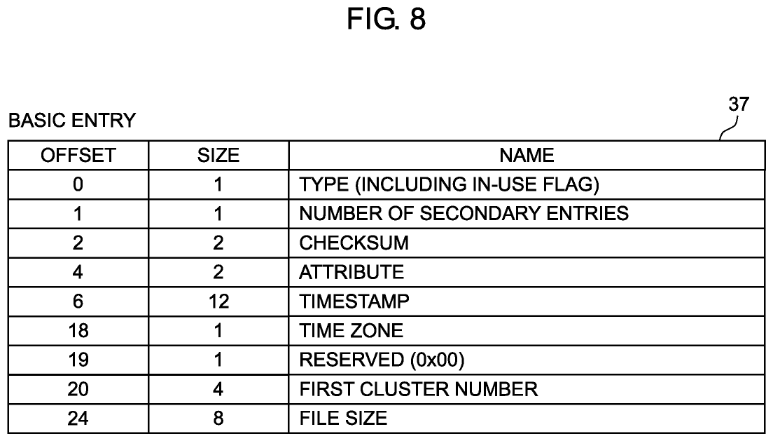

FIG. 8 is a view illustrating a structure of basic entry 37. Basic entry 37 is a directory entry storing basic information about a file. One basic entry 37 is necessarily included in entry sequence 40 of each file. The following will describe fields of basic entry 37.

The “type” field stores a fixed value indicating that this entry is basic entry 37.

The “number of secondary entries” field stores information indicating a number of secondary entries that follow basic entry 37. For example, when this field stores “10”, entry sequence 40 allocated to this file consists of 11 directory entries including the basic entry.

The “checksum” field stores a cyclic shift checksum value calculated for entry sequence 40. Thanks to this field, even when two or more directory entries are allocated to a single file, it is possible to detect inconsistency between the directory entries, thereby making it possible to enhance the reliability of the file system.

The “attribute” field stores information indicating a file attribute, such as a read-only attribute or a system file attribute.

The “timestamp” field stores a timestamp, such as a time and date when the file is created or a time and date when the file is updated.

The “time zone” field stores information indicating a time zone in which the timestamp is set.

The “reserved” field is reserved for future extensibility. This field normally stores a value of 0x00.

The “first cluster number” field stores a cluster number of a first cluster that is assigned at the beginning of an area storing the file data.

The “file size” field stores information indicating a size of the file.

In the present exemplary embodiment, information about a dummy file is set for basic entry 37, which is provided to manage the block available capacity table, according to the above-described format.

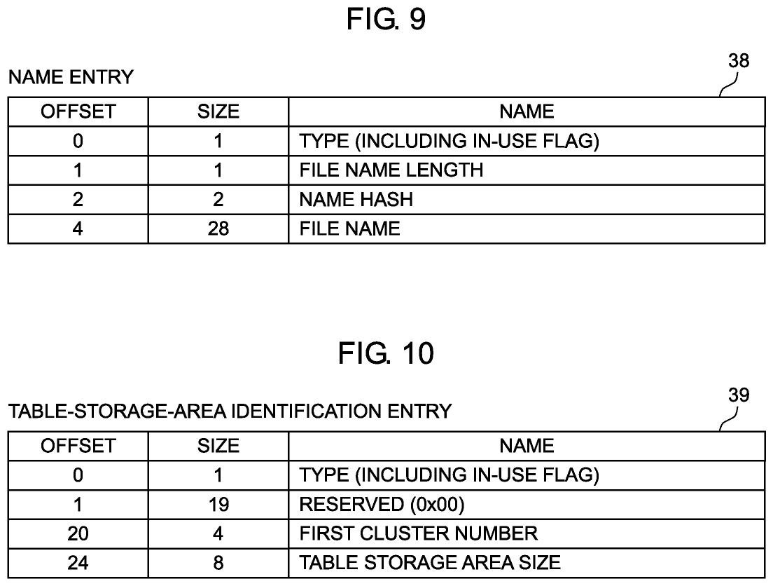

FIG. 9 is a view illustrating a structure of name entry 38. Name entry 38 is a directory entry storing the name of the file. Similarly to basic entry 37, one name entry 38 is necessarily included in entry sequence 40 of each file.

The “type” field stores a fixed value indicating that this entry is name entry 38.

The “file name length” field stores a length of the file name.

The “name hash” field stores a hash value of the file name.

The “file name” field stores the name of the file.

In the present exemplary embodiment, information about a dummy file is set for name entry 38, which is provided to manage the block available capacity table, according to the above-described format.

FIG. 10 is a view illustrating a structure of table-storage-area identification entry 39. Table-storage-area identification entry 39 is a directory entry storing information indicating a first cluster of table storage area 41, which is an area storing block available capacity table 43.

The “type” field stores a fixed value indicating that this entry is a table-storage-area identification entry.

The “reserved” field is reserved for future extensibility.

The “first cluster number” field indicates a cluster number of a first cluster assigned at the beginning of table storage area 41 storing block available capacity table 43.

The “table storage area size” field stores information indicating a size of table storage area 41.

As illustrated in FIG. 1, block available capacity table 43 is stored in a cluster block indicated by table-storage-area identification entry 39 (one of the special entries of exFAT).

As described above, block available capacity table 43 is managed according to the special entry (table-storage-area identification entry 39) provided in entry sequence 40. Thus, it is possible to manage block available capacity table 43 while retaining compatibility with the format of the existing file system.

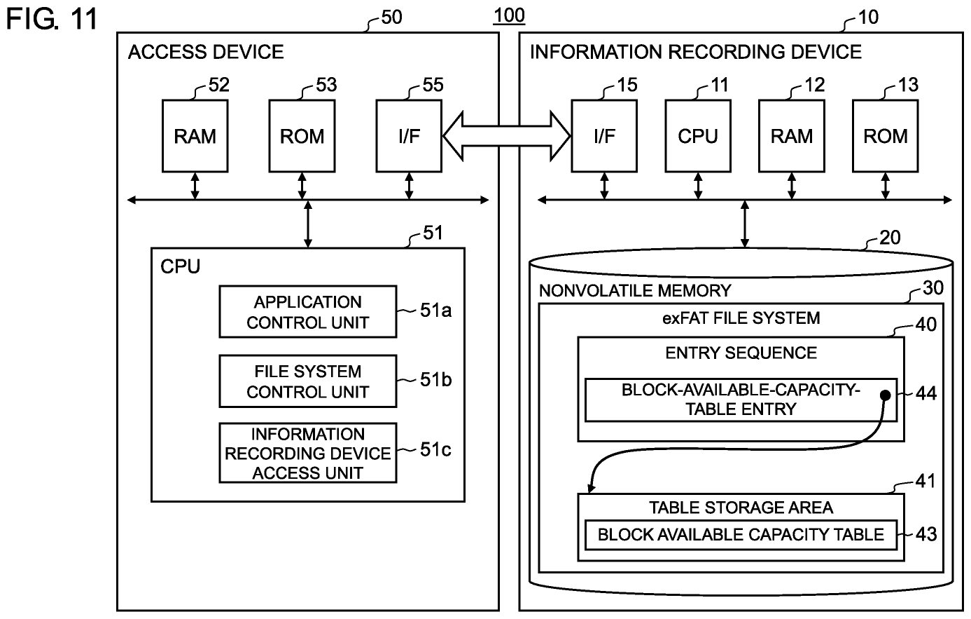

Note that the method for managing block available capacity table 43 is not limited to the above-described method. FIG. 11 illustrates another management method. As illustrated in FIG. 11, entry sequence 40 may not include the basic entry and the name entry, and may include only block-available-capacity-table entry 44 (special entries) storing information about table storage area 41.

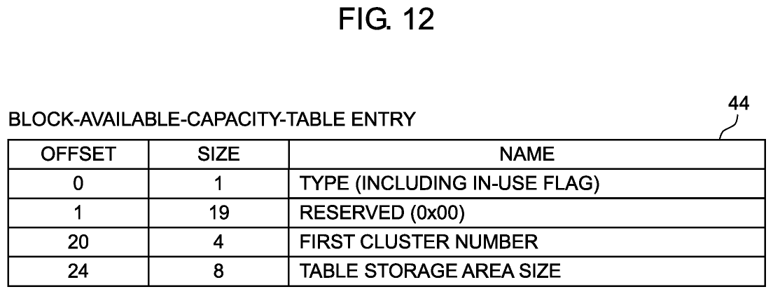

FIG. 12 is a view illustrating a structure of block-available-capacity-table entry 44. Block-available-capacity-table entry 44 is constituted by the following fields.

The “type” field stores a fixed value indicating that this entry is a block-available-capacity-table entry.

The “reserved” field is reserved for future extensibility.

The “first cluster number” field indicates a cluster number of a first cluster assigned at the beginning of table storage area 41 storing block available capacity table 43.

The “table storage area size” field stores information indicating a size of table storage area 41.

Also with this method, it is possible to manage block available capacity table 43 while retaining compatibility with the format of the existing file system.

### [1-3. Advantageous Effects and the Like]

As described above, information recording system 100 of the present exemplary embodiment includes information recording device 10 including nonvolatile memory 20 configured to store file data and access device 50 configured to access information recording device 10.

Information recording device 10 stores block available capacity table 43 (one example of available-capacity management information) according to which available capacities (e.g., the numbers of available clusters) of recording areas (recording areas each having a predetermined length) corresponding to AB blocks in nonvolatile memory 20 are managed.

Access device 50 includes: interface 55 via which access device 50 transmits file data to information recording device 10 and access device 50 receives file data from information recording device 10; and file system control unit 51b (one example of a control unit) configured to control recording of the file data on the information recording device with use of the file system.

At time of mounting of information recording device 10 on access device 50, file system control unit 51b retrieves block available capacity table 43 from information recording device 10 (S14). File system control unit 51b reconstructs block available capacity table 43 according to a data recorded state of nonvolatile memory 20 (S15). File system control unit 51b updates block available capacity table 43 in response to writing of data into nonvolatile memory 20 (S18). At time of unmounting of information recording device 10, file system control unit 51b records block available capacity table 43 on information recording device 10 (S23).

As described above, at the time of mounting, access device 50 retrieves block available capacity table 43 from information recording device 10, and updates block available capacity table 43 in response to recording of data. Meanwhile, at the time of unmounting, access device 50 writes updated block available capacity table 43 back into information recording device 10. In this manner, information recording device 10 stores block available capacity table 43 that is always up to date. Consequently, when information recording device 10 is mounted on access device 50, access device 50 can use available capacity table 43 that is up to date. By referring to block available capacity table 43 being in such a state, access device 50 can recognize an accurate availability state of information recording device 10, and thus can quickly search for an available area. Consequently, it is possible to reduce time taken to perform the data recording process.

With information recording system 100, file data to be stored in information recording device 10 is recorded with use of clusters according to the file system. The file system includes allocation bitmap 35 (one example of area management information). According to block available capacity table 43, available capacities of recording areas corresponding to AB blocks (one example of block areas) being defined by allocation bitmap 35 and each including a predetermined number of clusters are managed. With the configuration in which the available capacities of the areas (AB blocks) being defined by allocation bitmap 35 and each having a predetermined length are managed, it is possible to search for an available capacity quickly.

Information recording device 10 of the present exemplary embodiment is an information recording device (information recording medium) including nonvolatile memory 20 configured to store file data. The file data is managed based on clusters (one example of predetermined data units) according to the file system. Nonvolatile memory 20 stores allocation bitmap 35 (one example of the area management information), entry sequence 40 (the entry group), and block available capacity table 43 (one example of the available-capacity management information). Allocation bitmap 35 manages information as to whether or not each of the clusters has an available capacity (one example of information about the cluster). Entry sequence 40 incorporates at least one basic entry 37 and at least one name entry 38 (one example of a fixed-length entry). Basic entry 37 and name entry 38 are generated for every file data, and store management information including information indicating the name and size of the file. According to block available capacity table 43, available capacities of recording areas corresponding to the block areas (AB blocks) being defined by allocation bitmap 35 and each including the predetermined number of clusters are managed. Entry sequence 40 includes table-storage-area identification entry 39 (one example of an area identification entry) identifying table storage area 41 storing block available capacity table 43. Consequently, block available capacity table 43 can be managed according to the framework of the existing file system.

In addition, the present exemplary embodiment discloses the following method for managing the available capacity.

A method for managing an available capacity of information recording device 10 including nonvolatile memory 20 configured to store file data, the method being performed by access device 50 configured to access information recording device 10, the method including: at time of mounting of information recording device 10 on access device 50, retrieving from information recording device 10 block available capacity table 43 according to which available capacities of recording areas (areas corresponding to AB blocks) each having a predetermined length are managed (S14); reconstructing block available capacity table 43 according to a data recorded state of nonvolatile memory 20 (S15); updating block available capacity table 43 in response to writing of data into nonvolatile memory 20 (S18); and at time of unmounting of information recording device 10, recording block available capacity table 43 on information recording device 10 (S23).

With this method, information recording device 10 holds block available capacity table 43 that is always up to date. Consequently, it is possible to perform the available capacity search accurately and quickly, thereby making it possible to reduce process time taken to perform the writing process.

### Other Exemplary Embodiments

The first exemplary embodiment has been thus described as an example of the technique disclosed in the present application. However, the technique of the present disclosure is not limited to the first exemplary embodiment, and is also applicable to other exemplary embodiments that undergo some modifications, replacements, additions, omissions, or the like, as appropriate. In addition, new exemplary embodiments can be achieved by combining the elements described in the first exemplary embodiment. Thus, other exemplary embodiments are described below as examples.

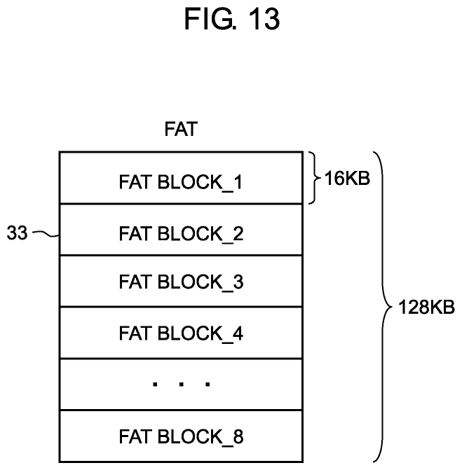

The exemplary embodiment described above uses the exFAT file system as the file system. Alternatively, the idea of the present disclosure is applicable also to other file systems such as FAT16 and FAT32. In this case, the block available capacity table may be generated based on information of FAT. For example, as disclosed in International Publication No. WO2009/150810, an area of FAT may be divided into a plurality of blocks each having a fixed length (hereinafter, referred to as “FAT blocks”), and available capacities of FAT blocks may be managed (see FIG. 13). For example, assume that FAT has FAT entries each of which corresponds to a single cluster and has a size of 32 bits. Then, with a single FAT block, an available capacity in a range of 4 K (=16 K×8/32) clusters can be managed. Namely, a block available capacity table may be configured to manage available capacities of divided FAT areas (blocks) each having a fixed length. In addition, an entry sequence may include another type of entry different from the entries in the exemplary embodiment described above.

The idea of the present disclosure is applicable also to a file system that is not the FAT file system. For example, an universal disk format (UDF) file system also has an allocation bitmap as the area management information. This allocation bitmap, which includes bits each indicating a used state of a single logical block, is provided as bitmap information including information about the bits corresponding to the number of all logical blocks managed by the UDF file system. Namely, this allocation bitmap also has a size proportional to a total capacity of the data recording area. Thus, also with the UDF file system to which the above-described idea is applied, it is possible to calculate divided available capacities. Consequently, it is possible to reduce time taken from initialization of the file system to start of recording.

The size of the AB block (see FIG. 3) or the size of the FAT block (see FIG. 13) in the exemplary embodiment described above is a mere example. The size of the AB block or the size of the FAT block may be determined as appropriate according to the expected application. For example, assuming that the technique of the present disclosure is used for a digital still camera that is the information recording device, the size of the AB block or the size of the FAT block may be determined according to a size of still image data generated by the digital still camera.

Each processing unit of the nonvolatile recording system, the access device, and the information recording device in the exemplary embodiment described above may be formed as a single chip with a semiconductor device such as large scale integration (LSI). Alternatively, some of or all of the processing units of the nonvolatile recording system, the access device, and the information recording device may be formed as a single chip.

Adopted as the semiconductor device technology herein is the LSI. Alternatively, the technology may be an integrated circuit (IC), system LSI, super LSI, or ultra LSI depending on the degree of integration of the circuit.

The circuit integration technology is not limited to the LSI, but the circuit integration may be achieved by a dedicated circuit or a general-purpose processor. A field programmable gate array (FPGA) whose circuit is programmable after the LSI is manufactured, or a reconfigurable processor in which connection and settings of circuit cells inside the LSI can be reconfigurable may be used.

Furthermore, if any circuit integration technology that can replace LSI emerges due to advancement of the semiconductor technology or other derivative technologies, such a technology may be used to integrate the functional blocks. Biotechnology may potentially be applicable.

The processes in the exemplary embodiment described above may be implemented by either hardware or software. Alternatively, the processes may be implemented by a combination of software and hardware. In a case where the nonvolatile recording system, the access device, and the information recording device in the exemplary embodiment described above are implemented by hardware, it is naturally necessary to perform timing adjustment for the processes of the nonvolatile recording system, the access device, and the information recording device. For ease of explanation, the exemplary embodiment described above omits details of timing adjustment associated with various signals required in an actual hardware design.

As described above, the exemplary embodiments have been described as examples of the technique of the present disclosure. For this purpose, the accompanying drawings and the detailed description have been provided.

Therefore, the elements in the accompanying drawings and the detailed description may include elements essential for solving the problems, as well as elements that are not essential for solving the problems but required to exemplify the above techniques. Thus, these unessential elements should not be deemed as essential just because these unessential elements are included in the accompanying drawings and the detailed description.

The exemplary embodiments described above are mere examples of the technique according to the present disclosure, and therefore various changes, substitutions, additions, omissions, and the like can be made within the scope of the claims and the scope of equivalents thereof.

### INDUSTRIAL APPLICABILITY

The present disclosure is useful for devices for recording data in a nonvolatile memory.

### REFERENCE MARKS IN THE DRAWINGS

10: information recording device
20: nonvolatile memory
22: file system management information area
24: user data area
30: exFAT file system
31: master boot record/partition table
32: boot area
33: FAT
35: allocation bitmap
37: basic entry
38: name entry
39: table-storage-area identification entry
40: entry sequence
41: table storage area
43: block available capacity table
44: block-available-capacity-table entry
50: access device
51: CPU
51a: application control unit
51b: file system control unit
51c: information recording device access unit
100: information recording system

1. A method for managing an available capacity of an information recording device including a nonvolatile memory configured to store file data, the method being performed by an access device configured to access the information recording device, the method comprising:
at time of mounting of the information recording device on the access device, retrieving, from the information recording device, available-capacity management information according to which available capacities of recording areas are managed, each of the recording areas having a predetermined length;
reconstructing the available-capacity management information based on a state of recording of data on the nonvolatile memory;
updating the available-capacity management information in response to writing of data into the nonvolatile memory; and
at time of unmounting of the information recording device, recording the available-capacity management information on the information recording device.

2. The method for managing the available capacity according to claim 1, wherein
file data to be stored in the information recording device is recorded with use of predetermined data units according to a file system, and the file system includes area management information according to which pieces of information about the respective data units are managed, and
according to the available-capacity management information, the available capacities of the recording areas corresponding to block areas being defined by the area management information and each including a predetermined number of the data units are managed.

3. The method for managing the available capacity according to claim 2, wherein the area management information is constituted by a plurality of bits corresponding to the respective data units, each of the plurality of bits indicating whether or not a corresponding one of the data units is available.

4. The method for managing the available capacity according to claim 2, wherein the area management information indicates a link between the data units used to record the file data.

5. The method for managing the available capacity according to claim 2, further comprising:
referring to the area management information to search for the block areas each having an available capacity, in response to a request to record the file data on the information recording device, the request being given by the access device; and
reconstructing the available-capacity management information, in response to recording of the file data on each of the block areas having been selected.

6. The method for managing the available capacity according to claim 1, wherein
the file data is managed with use of an entry group incorporating at least one fixed-length entry which is generated for every file data and which stores management information including information indicating a name and a size of a file, and
the entry group includes an area identification entry identifying an area storing the available-capacity management information.

7. The method for managing the available capacity according to claim 6, wherein in the entry group, the area identification entry is disposed to follow an entry including information indicating a name and a size of a dummy file.

8. An access device configured to access an information recording device including a nonvolatile memory configured to store file data, the access device comprising:
an interface configured to transmit the file data to the information recording device and to receive the file data from the information recording device; and
a control unit configured to control recording of the file data on the information recording device with use of a file system, wherein
at time of mounting of the information recording device on the access device, the control unit retrieves, from the information recording device, available-capacity management information according to which available capacities of recording areas are managed, each of the recording areas having a predetermined length,
the control unit reconstructs the available-capacity management information based on a state of recording of data on the nonvolatile memory,
the control unit updates the available-capacity management information in response to writing of data into the nonvolatile memory, and
at time of unmounting of the information recording device, the control unit records the available-capacity management information on the information recording device.

9. The access device according to claim 8, wherein
file data to be stored in the information recording device is recorded with use of predetermined data units according to a file system, and the file system includes area management information according to which pieces of information about the respective data units are managed, and
according to the available-capacity management information, the available capacities of the recording areas of the nonvolatile memory are managed, the recording areas corresponding to block areas being defined by the area management information and each including a predetermined number of data units.

10. The access device according to claim 9, wherein the area management information is constituted by a plurality of bits corresponding to the respective data units, each of the plurality of bits indicating whether or not a corresponding one of the data units is available.

11. The access device according to claim 9, wherein the area management information indicates a link between the data units used to record the file data.

12. The access device according to claim 8, wherein
the file data is managed with use of an entry group incorporating at least one fixed-length entry which is generated for every file data and which stores management information including information indicating a name and a size of a file, and
the entry group includes an area identification entry identifying an area storing the available-capacity management information.

13. The access device according to claim 12, wherein in the entry group, the area identification entry is disposed to follow an entry including information indicating a name and a size of a dummy file.

14. An information recording device comprising a nonvolatile memory configured to store file data, wherein
the file data is managed based on predetermined data units according to a file system,
the nonvolatile memory includes
area management information according to which pieces of information about the respective data units are managed,
an entry group incorporating at least one fixed-length entry being generated for every file data and storing management information including information indicating a name and a size of a file, and
available-capacity management information according to which available capacities of recording areas corresponding to block areas being defined by the area management information and each including a predetermined number of the data units are managed, and
the entry group includes an area identification entry identifying an area storing the available-capacity management information.

15. An information recording system, comprising:
an information recording device including a nonvolatile memory configured to store file data; and
an access device configured to access the information recording device, wherein
the information recording device stores available-capacity management information according to which available capacities of recording areas are managed, each of the recording areas having a predetermined length,
the access device includes
an interface configured to transmit the file data to the information recording device and to receive the file data from the information recording device, and
a control unit configured to control recording of the file data on the information recording device with use of a file system,
the control unit retrieves the available-capacity management information from the information recording device, at time of mounting of the information recording device on the access device,
the control unit reconstructs the available-capacity management information based on a state of recording of data on the nonvolatile memory,
the control unit updates the available-capacity management information in response to writing of data into the nonvolatile memory, and
the control unit records the available-capacity management information on the information recording device, at time of unmounting of the information recording device.
